(19) United States
(12) Patent Application Publication
(10) Pub. No.: US 2026/0265513 A1
(43) Pub. Date: Sep. 10, 2026

(54) POLYOLEFIN COMPOSITIONS OBTAINED FROM RECYCLED POLYOLEFINS

(71) Applicant: Basell Poliolefine Italia S.r.l., Milano (IT)

(72) Inventor: Claudio Cavalieri, Ferrara (IT)

(73) Assignee: Basell Poliolefine Italia S.r.l., Milano (IT)

(21) Appl. No.: 19/559,623

(22) Filed: Mar. 6, 2026

(30) Foreign Application Priority Data
Mar. 10, 2025 (EP) 25162640.4

(51) Int. Cl. C08L 23/14; B32B 27/08; B32B 27/32

(52) U.S. Cl. CPC C08L 23/14; B32B 27/08; B32B 27/32; B32B 2250/03; B32B 2250/242; B32B 2250/40; B32B 2305/70; B32B 2307/546; B32B 2307/558; C08L 2203/16; C08L 2205/025; C08L 2205/03; C08L 2207/20

(57) ABSTRACT

A multilayer film made from or containing:
I. at least one core layer made from or containing
   i. a polypropylene composition made from or containing
      A) from 55 wt. % to 85 wt. % of a recycled a recycled polypropylene; and
      B) from 15 wt. % to 45 wt. % of a virgin polypropylene composition made from or containing:
         (b1) from 75 wt. % to 95 wt. % of a propylene homopolymer, and
         (b2) from 5 wt. % to 25 wt. % of a copolymer of propylene and ethylene.

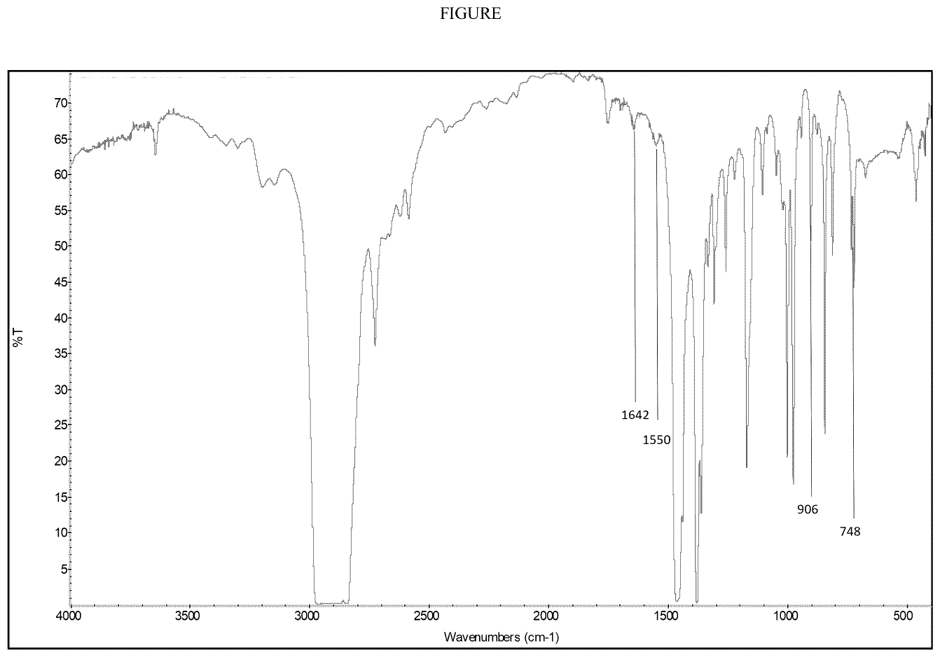

### PRIOR RELATED APPLICATION

This application claims the benefit of priority to European Patent Application No. 25162640.4, filed on Mar. 10, 2025, which is incorporated here by reference in its entirety.

### FIELD OF THE INVENTION

In general, the present disclosure relates to the field of chemistry. More specifically, the present disclosure relates to polymer chemistry. In particular, the present disclosure relates to a polymer film, a polymer film suitable for the packaging of food, or a polymer film containing recycled polymeric material.

### BACKGROUND OF THE INVENTION

In some instances, polypropylene films as well as biaxially oriented polypropylene films (BOPP) are used for the packaging of foodstuff using automatic machines. In some instances, the film have a balance of processability (“machinability”), optical and mechanical properties, and permeability to gases and water vapor. In some instances, the gases are oxygen or carbon dioxide or water vapor.

Despite performance, polypropylene films have given rise to concerns in terms of sustainability because the production of polypropylene films is based on the use of non-renewable sources.

In some instances, attempts to mitigate concerns include replacing, at least in part, virgin polyolefin compositions with recycled plastic materials.

In some instances, recycled plastic polyolefin are derived from streams of post-consumer waste (PCW) or post-industrial waste (PIW).

In some instances, a challenge in polyolefin recycling is the difficulty to quantitatively separate the various types of polymers. As such, some commercially available recycled products are almost invariably contaminated with heterogeneous materials of various source.

Consequently, polymer compositions containing recycled materials are often regarded as having reduced reliability and performance relative to compositions composed exclusively of virgin polymers.

It has now been unexpectedly found that it is possible to produce a multilayer film wherein the core layer comprises a recycled polypropylene with reduced migration of contaminant.

### SUMMARY OF THE INVENTION

The present disclosure provides a multilayer film made from or containing:
I. at least one core layer made from or containing
   i. a polypropylene composition made from or containing
      A) from 55 wt. % to 85 wt. % of a recycled a recycled polypropylene (r-PP), having the following features:
         A.1. a propylene derived units content, measured with 13C-NMR, higher than 60 wt. %;
         A.2. an ethylene derived units content, measured with 13C-NMR, between 1.5 wt. % and 20.3 wt. %;
         A.3. a Melt Flow Rate (ISO 1133 230° C./2.16 kg) ranging from 0.2 to 20 g/10 min;
         A.4. a fraction soluble in xylene at 25° C., determined according to ISO 16152:2005, lower than 15.0 wt. %;
         A.5. a flexural modulus, measured according to ISO 527-2, ranging from 820 N/mm² to 1720 N/mm²;
         A.6. a Charpy impact test at 23° C., determined according to ISO 179-1eA, and ISO 1873-2, ranging from 2.2 KJ/m² to 13.0 KJ/m²;
         A.7. an elongation at break, measured according to ISO 527, ranging from 50% to 200%; and
         A.8. the FTIR spectrum of film showing at least two peaks at different wavenumbers (cm−1) selected from the group consisting of: 3303±1 cm⁻¹; 1726±1 cm⁻¹; 1642±1 cm⁻¹; 1600±1 cm 1; 1550±1 cm⁻¹; 906±1 cm⁻¹; 839±1 cm⁻¹, 818±1 cm⁻¹; 748±1 cm⁻¹; and 695±1 cm⁻¹; and
      B) from 15 wt. % to 45 wt. % of a virgin polypropylene composition made from or containing:
         (b1) from 75 wt. % to 95 wt. % of a propylene homopolymer, having:
         (b1.1) a fraction soluble in xylene at 25° C. lower than 6.0 wt. %; and
         (b1.2) a Melt Flow Rate (ISO 1133 230° C./5.0 kg) ranging from 0.1 to 6.0 g/10 min; and
         (b2) from 5 wt. % to 25 wt. % of a copolymer of propylene and ethylene, having:
         (b2.1) units derived from ethylene, measured according to ¹³C-NMR, in an amount ranging from 25.0 wt. % to 68.0 wt. %;
         wherein the polypropylene composition (B), having the follow features:
         B.1. a Melt Flow Rate (ISO 1133 230° C./5.0 kg) ranging from 0.4 to 5.0 g/10 min;
         B.2. an amount of fraction soluble in xylene at 25° C. ranging from 7.0 wt. % to 18.0 wt. %;
         B.3. an intrinsic viscosity fraction soluble in xylene at 25° C., measured in tetrahydronaphthalene at 135° C., ranging from 1.2 to 7.5 dl/g; and
         B.4. a total content of ethylene, measured according to 13C-NMR, ranging from 4.0 wt. % to 10.0 wt. %;
   wherein, in the polypropylene composition (i), the sum of b1) and b2), being referred to the total weight of b1) and b2), is 100, and the sum of the amounts of (A) and (B), being referred to the total weight of (A) and (B), is 100.

### BRIEF DESCRIPTION OF THE DRAWINGS

The FIGURE shows an FTIR spectrum of an exemplar of an embodiment of component A).

### DETAILED DESCRIPTION OF THE INVENTION

In some embodiments, the multilayer film is made from or containing:
I. at least one core layer made from or containing
   i. a polypropylene composition made from or containing
      A) from 55 wt. % to 85 wt. %; alternatively from 60 wt. % to 80 wt. %; alternatively from 65 wt. % to 75 wt. %; of a recycled a recycled polypropylene (r-PP), having the following features:
         A.1. a propylene derived units content, measured with 13C-NMR, higher than 60 wt. %, alternatively higher than 65 wt. %; alternatively higher than 70 wt. %;
         A.2. an ethylene derived units content, measured with 13C-NMR, between 1.5 wt. % and 20.3 wt. %, alternatively between 3.0 wt. % and 18.2 wt. %, alternatively between 5.5 wt. % and 16.4 wt. %;
         A.3. a Melt Flow Rate (ISO 1133 230° C./2.16 kg) ranging from 0.2 to 20 g/10 min; alternatively ranging from 1 to 15 g/10 min; alternatively ranging from 3 to 10 g/10 min;
         A.4. a fraction soluble in xylene at 25° C., determined according to ISO 16152:2005, lower than 15.0 wt. %; alternatively lower than 13.0 wt. %; alternatively lower than 11.0 wt. %;
         A.5. a flexural modulus, measured according to ISO 527-2, ranging from 820 N/mm² to 1720 N/mm²; alternatively ranging from 950 N/mm² to 1550 N/mm²; alternatively ranging from 1050 N/mm² to 1480 N/mm²;
         A.6. a Charpy impact test at 23° C., determined according to ISO 179-1eA, and ISO 1873-2, ranging from 2.2 KJ/m² to 13.0 KJ/m²; alternatively ranging from 3.4 KJ/m² to 10.2 KJ/m²; alternatively ranging from 4.0 KJ/m² to 8.3 KJ/m²;
         A.7. an elongation at break, measured according to ISO 527, ranging from 50% to 200%; alternatively ranging from 75% to 180%; alternatively ranging from 95% to 160%;
         A.8. the FTIR spectrum of film showing at least two peaks at different wavenumbers (cm−1) selected from the group consisting of: 3303±1 cm⁻¹; 1726±1 cm⁻¹; 1642±1 cm⁻¹; 1600±1 cm 1; 1550±1 cm⁻¹; 906±1 cm⁻¹; 839±1 cm⁻¹, 818±1 cm⁻¹; 748±1 cm⁻¹; and 695±1 cm⁻¹; and
      B) from 15 wt. % to 45 wt. %; alternatively from 20 wt. % to 40 wt. %; alternatively from 25 wt. % to 35 wt. %; of a virgin polypropylene composition made from or containing:
         (b1) from 75 wt. % to 95 wt. %, alternatively from 81 wt. % to 93 wt. %; alternatively from 85 wt. % to 92 wt. %; of a propylene homopolymer, having:
         (b1.1) a fraction soluble in xylene at 25° C. lower than 6.0 wt. %; alternatively lower than 3.0 wt. %; alternatively lower than 2.8 wt. %; alternatively lower than 2.2 wt. %; and
         (b1.2) a Melt Flow Rate (ISO 1133 230° C./5.0 kg) ranging from 0.1 to 6.0 g/10 min; alternatively ranging from 0.5 to 2.5 g/10 min; alternatively ranging from 0.6 to 1.7 g/10 min; and
         (b2) from 5 wt. % to 25 wt. %; alternatively from 7 wt. % to 19 wt. %; alternatively from 8 wt. % to 15 wt. %; of a copolymer of propylene and ethylene, having:
         (b2.1) units derived from ethylene, measured according to ¹³C-NMR, in an amount ranging from 25.0 wt. % to 68.0 wt. %; alternatively from 35.0 wt. % to 68.0 wt. %; alternatively ranging from 41.0 wt. % to 57.0 wt. %; alternatively ranging from 46.0 wt. % to 54.0 wt %;
         wherein the polypropylene composition (B), having the follow features:
         B.1. a Melt Flow Rate (ISO 1133 230° C./5.0 kg) ranging from 0.4 to 5.0 g/10 min; alternatively from 0.4 to 3.0 g/10 min; alternatively ranging from 0.5 to 2.50 g/10 min; alternatively ranging from 0.6 to 1.7 g/10 min;
         B.2. an amount of fraction soluble in xylene at 25° C. ranging from 7.0 wt. % to 18.0 wt. %; alternatively from 8.0 wt. % to 16.0 wt. %; alternatively from 8.5 wt. % to 12.4 wt. %;
         B.3. an intrinsic viscosity fraction soluble in xylene at 25° C., measured in tetrahydronaphthalene at 135° C., ranging from 1.2 to 7.5 dl/g; alternatively from 3.0 to 7.5 dl/g; alternatively ranging from 3.5 to 5.5 dl/g; alternatively ranging from 3.7 to 5.2 dl/g; and
         B.4. a total content of ethylene, measured according to 13C-NMR, ranging from 4.0 wt. % to 10.0 wt. %; alternatively from 4.0 wt. % to 7.0 wt. %; alternatively ranging from 4.2 wt. % to 5.8 wt. %; alternatively ranging from 4.5 wt. % to 5.4 wt. %;
   wherein, in the polypropylene composition (i), the sum of b1) and b2), being referred to the total weight of b1) and b2), is 100, and the sum of the amounts of (A) and (B), being referred to the total weight of (A) and (B), is 100.
      In some embodiments, component (A) has a fraction soluble in xylene at 25° C. (A.4.), determined according to ISO 16152:2005, higher than 4.0 wt. %. In some embodiments, component (b1), being a propylene homopolymer component of component (B), has a fraction soluble in xylene at 25° C. higher than 0.5 wt. %.

As used herein, the term “copolymer” refers to polymers with two different recurring units.

As used herein, the term “recycled” refers to a material containing polymers whose pellets have been processed more than one time. As used herein and on the contrary to recycled, the term “virgin” refers to the polymers pellets which are yet to be processed.

In some embodiments, Component A) is a Post-Industrial Resin (PIR) or a Post-Consumer Resin (PCR).

As used herein, the term “Post-Industrial Resin (PIR)” refers to the waste generated from the manufacturing process that is reclaimed or used again in the same material.

As used herein, the term “Post-Consumer Resin (PCR)” refers to a resin used by the consumer for the resin's intended purpose, which has reached the resin's end of use, and was then tossed into a recycling bin. In some embodiments, Post-Consumer Resin is excluded.

In some embodiments, the recycled propylene-based polymers contains from 0.1 ppm to 25 ppm of limonene.

In some embodiments, the recycled polypropylene composition is further made from or containing other polypropylene or polyethylene based polymers component c). In some embodiments, the other polypropylene based polymers are virgin polypropylene based polymers. In some embodiments, the other polypropylene based polymers are selected from the group consisting of propylene homopolymer, propylene ethylene copolymer having an ethylene derived units content ranging from 0.5 wt. % to 10.0 wt. %, heterophasic propylene ethylene copolymer having a xylene soluble fraction at 25° C. ranging from 8.0 wt. % to 50.0 wt. %, propylene ethylene 1-butene terpolymer, and propylene ethylene 1-hexene terpolymer.

In some embodiments, when the term “consisting essentially of” is referred to a polymer or polymer composition, the term means that, in addition to the specified components, the polymer or the polymer composition may be further made from or containing other components, provided that the characteristics of the polymer or of the composition are not materially affected by the presence of the other components. In some embodiments, the other components are selected from the group consisting of catalyst residues, antistatic agents, melt stabilizers, light stabilizers, antioxidants, and antiacids.

In some embodiments, the features of the components forming the polypropylene composition are not inextricably linked to each other. In some embodiments, a level of a feature does not involve the same level of the remaining features of the same or different components. In some embodiments, any component (A) to (B) and any range of features of components (A) to (B) is combined with any range of one or more of the features of components (A) to (B) and with any additional component, and the component's features.

As used herein, the term “core layer” refers to the layer in a multilayer film having no contact with the external environment. For example, in a three-layer A/B/A film, the B layer is the core layer.

In some embodiments, the multilayer films have at least one of the core layers made from or containing the polypropylene composition. In some embodiments, the remaining layers are made from or containing other materials for use in multilayer films or in laminated products. In some embodiments, each layer is made from or containing a polypropylene homopolymer, a polypropylene copolymer, a polyethylene homopolymer, a polyethylene copolymer, or other polymers. In some embodiments, the other polymer is EVA. In some embodiments, the outer layer is made from or containing a homopolymer of propylene. In some embodiments, the homopolymer of propylene is commercially available under the tradenames Mollen HP522H, Moplen HP520H, Moplen HP525J, Moplen HP740J or Moplen HP526J.

The combination and number of layers of the multilayer structures described are not limited. In some embodiments, the multilayer structure is made from or containing 3-11 layers or more, alternatively 3-9 layers, alternatively 3-7 layers, alternatively 3-5 layers. In some embodiments, the multilayer structure have layer combinations including A/B/A, A/B/C, A/B/C/B/A, or A/B/C/D/C/B/A, wherein at least one core layer is made from or containing the propylene composition. In some embodiments, the core layer is as B or D.

In some embodiments, the number of layers of the multilayer film is 3, alternatively 5, wherein at least one core layer is made from or containing the propylene composition. In some embodiments, the structures are A/B/A or A/B/C, wherein B is the propylene composition.

In some embodiments, the melting temperature of component b1), determined via DSC, ranges from 155° C. to 165° C.

In some embodiments, Component B) is prepared by polymerizing propylene, optionally in mixture with ethylene, in the presence of a catalyst made from or containing the product of the reaction between:
a) a solid catalyst component made from or containing Ti, Mg, Cl, and an internal electron donor compound;
ii) an alkylaluminum compound; and
iii) an external electron-donor compound having the formula:
(R⁷)^{a}(R⁸)_{b}Si(OR⁹)_{c}, where a and b are integers from 0 to 2, c is an integer from 1 to 4 and the sum (a+b+c) is 4; R⁷, R⁸, and R⁹, are alkyl, cycloalkyl or aryl radicals with 1-18 carbon atoms optionally containing heteroatoms.

In some embodiments, the internal donor is selected from the esters of mono or dicarboxylic organic acids. In some embodiments, the esters are selected from the group consisting of benzoates, malonates, phthalates, and certain succinates. In some embodiments, the internal donors are as described in U.S. Pat. No. 4,522,930A, European Patent Application No. 045977A2 and Patent Cooperation Treaty Publication Nos. WO 00/63261 and WO 01/57099.

In some embodiments, the internal donor is selected from the group consisting of phthalic acid esters and succinate acids esters. In some embodiments, the internal donor is an alkylphthalate. In some embodiments, the alkylphthalate is selected from the group consisting of diisobutyl phthalate, dioctyl phthalate, diphenyl phthalate and benzyl-butyl phthalate.

In some embodiments, the particles of solid component (i) have substantially spherical morphology and an average diameter ranging between 5 and 150 μm, alternatively from 20 to 100 μm, alternatively from 30 to 90 μm. As used herein, the term “substantially spherical morphology” refers to particles having the ratio between the greater axis and the smaller axis equal to or lower than 1.5, alternatively lower than 1.3.

In some embodiments, the amount of Mg ranges from 8 to 30%, alternatively from 10 to 25 wt. %.

In some embodiments, the amount of Ti ranges from 0.5 to 7 wt. %, alternatively from 0.7 to 5 wt. %.

In some embodiments, the solid catalyst component (i) is prepared by reacting a titanium compound of formula Ti(OR)_{q-y}X_{y}, where q is the valence of titanium and y is a number between 1 and q, with a magnesium chloride deriving from an adduct of formula MgCl₂·pROH, where p is a number between 0.1 and 6, alternatively from 2 to 3.5, and R is a hydrocarbon radical having 1-18 carbon atoms. In some embodiments, the titanium compound is TiCl₄. In some embodiments, the adduct is prepared in spherical form by mixing alcohol and magnesium chloride, operating under stirring conditions at the melting temperature of the adduct (100-130° C.). Then, the adduct is mixed with an inert hydrocarbon immiscible with the adduct, thereby creating an emulsion which is quickly quenched and causing the solidification of the adduct in form of spherical particles. In some embodiments, the procedure for the preparation of the spherical adducts is as disclosed in U.S. Pat. Nos. 4,399,054 and 4,469,648. In some embodiments, the adduct is directly reacted with Ti compound or subjected to thermal controlled dealcoholation (80-130° C.), thereby obtaining an adduct wherein the number of moles of alcohol is lower than 3, alternatively between 0.1 and 2.5. In some embodiments, the reaction with the Ti compound is carried out by suspending the adduct (dealcoholated or as such) in cold TiCl₄. The mixture is heated up to 80-130° C. and maintained at this temperature for 0.5-2 hours. In some embodiments, the treatment with TiCl₄ is carried out one or more times. In some embodiments, the electron donor compound is added during the treatment with TiCl₄.

In some embodiments, the alkyl-Al compound (ii) is selected from the group consisting of trialkyl aluminum compounds, alkylaluminum halides, alkylaluminum hydrides, and alkylaluminum sesquichlorides. In some embodiments, the alkyl-Al compound (ii) is a trialkyl aluminum compound selected from the group consisting of triethylaluminum, triisobutylaluminum, tri-n-butylaluminum, tri-n-hexylaluminum, and tri-n-octylaluminum. In some embodiments, the alkyl-Al compound (ii) is an alkylaluminum sesquichloride selected from the group consisting of AlEt₂Cl and Al₂Et₃Cl₃. In some embodiments, the alkyl-Al compound (ii) is a mixture including trialkylaluminums. In some embodiments, the Al/Ti ratio is higher than 1, alternatively ranges between 50 and 2000.

In some embodiments, the silicon compounds (iii) are wherein a is 1, b is 1, c is 2, at least one of R⁷ and R⁸ is selected from branched alkyl, cycloalkyl or aryl groups with 3-10 carbon atoms, optionally containing heteroatoms, and R⁹ is a C1-C10 alkyl group. In some embodiments, R⁹ is methyl. In some embodiments, the silicon compounds are selected from the group consisting of methylcyclohexyldimethoxysilane (C donor), diphenyldimethoxysilane, methyl-t-butyldimethoxysilane, dicyclopentyldimethoxysilane (D donor), diisopropyldimethoxysilane, (2-ethylpiperidinyl) t-butyldimethoxysilane, (2-ethylpiperidinyl) thexyldimethoxysilane, (3,3,3-trifluoro-n-propyl) (2-ethylpiperidinyl) dimethoxysilane, and methyl (3,3,3-trifluoro-n-propyl) dimethoxysilane. In some embodiments, the silicon compounds are wherein a is 0, c is 3, R⁸ is a branched alkyl or cycloalkyl group, optionally containing heteroatoms, and R⁹ is methyl. In some embodiments, the silicon compounds are selected from the group consisting of cyclohexyltrimethoxysilane, t-butyltrimethoxysilane and thexyltrimethoxysilane.

In some embodiments, the amount of external electron donor compound (iii) provides a molar ratio between the alkylaluminum compound and the external electron donor compound (iii) of from 0.1 to 200, alternatively from 1 to 100, alternatively from 3 to 50.

In some embodiments, Component B) is prepared in a continuous sequential polymerization process, wherein component b1) is prepared in a first reactor and component (b2) is prepared in a second reactor in the presence of component b1). In some embodiments, the polymerization process is operating in gas phase, in liquid phase in the presence or not of inert diluent, or by mixed liquid-gas techniques.

In some embodiments, Component B) is a commercial polymer grade. In some embodiments, the polymer grade is commercially available under the tradename Hostalen PP H2483 from LyondellBasell.

In some embodiments, Component (A) originates either from post-consumer waste (PostCW) or from pre-consumer waste (Pre-CW). In some embodiments, Component (A) originates from Pre-CW. The pre-consumer plastic is regarded as a plastic waste diverted from a manufacturing process, which is not reutilized, such as rework, regrind or scrap, and is not reincorporated in the same process that generated the pre-consumer plastic.

In some embodiments, the final composition made from or containing (A)+ (B) is subjected to a chemical treatment with organic peroxides, thereby lowering the average molecular weight and increasing the melt flow index. In some embodiments, the melt flow index is increased for a certain application.

In some embodiments, the whole polypropylene composition has a tensile modulus value lower than the tensile module value of component B). In some embodiments, the tensile modulus of the whole propylene polymer composition ranges from to 750 MPa to 1700 MPa, alternatively from 900 to 1650 MPa.

In some embodiments, the polypropylene composition has a Charpy impact at 23° C. ranging from 30.0 Kj/m² to 5.0 Kj/m². In some embodiments, the polypropylene composition has a Charpy impact at 0° C. ranging from 2.0 Kj/m² to 10.0 Kj/m². In some embodiments, the polypropylene composition has a Charpy impact at −20° C. ranging from 1.0 Kj/m² to 7.0 Kj/m².

In some embodiments, the whole propylene composition is obtained by mechanical blending of the components (A) and (B).

In some embodiments, the multilayer film shows a low migration when the core layer is contaminated. In some embodiments, the multilayer film is made from or containing a recycled material. In some embodiments, the multilayer film is used for the packaging of food alternatively fresh foodstuff. In some embodiments, the fresh foodstuff is selected from the group consisting of salad and vegetables.

In some embodiments, the film layers are further made from or containing additives. In some embodiments, the films are used for packaging applications with automatic machines. In some embodiments, the additives are selected from the group consisting of anti-oxidants, process stabilizers, slip agents, antistatic agents, antiblock agents, and antifog agents.

In some embodiments and independently from the structure of the film, the overall film thickness is from 9 to 100 microns. In some embodiments and independently from the structure of the film, the thickness of the layer(s) A) is from 0.5 to 20 microns. In some embodiments and independently from the structure of the film, the thickness of the layer(s) B) is from 9.5 to 99.5 microns. In some embodiments, the layer B) is as an inner layer.

In some embodiments, the films are produced by various processes.

In some embodiments, the films are produced using extrusion processes.

In some embodiments and using extrusion processes, the polymer materials for the various layers are molten in different extruders and extruded through a narrow die gap. In some embodiments and subsequent from the exit from the die, the material is cooled, heated and optionally oriented in several ways or in combination. In some embodiments, the processes are selected from the group consisting of cast, blown, extrusion coating, uniaxially oriented, simultaneous biaxially oriented, and sequential biaxially oriented film processes.

### Blown Film

In some embodiments and in the case of a blown-film process, the molten polymer materials are forced through a circular shaped die.

The extrudate, which is drawn off, has the shape of a tube, which is inflated by air, thereby forming a tubular bubble. The bubble is cooled and collapsed before winding-up.

### BOPP

In some embodiments and in the case of a biaxially oriented polypropylene (BOPP) film process, the molten polymer materials are forced continuously through a narrow die. The extruded molten material is pulled away from the die and cooled, then heated again and stretched both in the Machine Direction (MD) and in the Transverse Direction (TD). After the stretching process, the film is cooled and then wound-up.

The following examples are given to illustrate and not limit the present disclosure.

### EXAMPLES

### Characterizations

Determination of the Composition of Recycled Polymer (PP Repro) Via ¹H and ¹³C NMR

PP repro is a mixture of polymers, having an aliphatic hydrocarbon backbone (ethylene-E), propylene-P), 1-butene (B, <1.0 wt. %), 1-hexene (H, <1.0 wt. %) and 1-octene (O, <1.0 wt. %) copolymers and possibly an aromatic hydrocarbon backbone (polystyrene and polyethylene terephthalate). Due to analytical complications in determining the composition of aromatic containing polymers via ¹³C NMR spectroscopy, the method was developed by using the combination of the results obtained via ¹H and ¹³C NMR spectra. ¹³C NMR was used to determine the relative amount of ethylene, propylene 1-butene, 1-hexene, and 1-octene copolymers while ¹H NMR provided a quantification of the composition of aliphatic and aromatic components and the relative amounts of polystyrene and polyethylene terephthalate when present.

¹³C NMR and ¹H spectra were acquired on a Bruker AV600 spectrometer, equipped with cryoprobe, operating at 150.91 MHz and 600.13 MHz respectively in the Fourier transform mode at 120° C.

About 30 mg of sample were dissolved at 120° C. in 0.5 ml of 1,1,2,2 tetrachloroethane-d2 added with 0.1 mg/ml of Irganox 1010 (AO 1010) as antioxidant

For ¹³C NMR spectra, the peak of the Sδδ carbon (nomenclature according C. J. Carman, R. A. Harrington and C. E. Wilkes, Macromolecules, 10, 3, 536 (1977)) was used as internal standard at 29.9 ppm. Each spectrum was acquired with a 90° pulse, 15 seconds of delay between pulses and CPD, thereby removing ¹H-¹³C coupling. 512 transients were stored in 65 K data points, using a spectral window of 9000 Hz.

For ¹H NMR spectra, the peak of the residual C₂DHCl₄ at 5.95 ppm was used as internal standard. Each spectrum was acquired with a 90° pulse, 5 seconds of delay between pulses and 128 transients stored in 64K data points, using a spectral window of 9600 Hz.

### Evaluation of ¹³C NMR Spectrum of Ethylene, Propylene, 1-Butene, 1-Hexene and 1-Octene Copolymers

In the ¹³C NMR spectrum, the signals from Ethylene, Propylene, 1-Butene, 1-Hexene and 1-Octene copolymers, in the absence of other signals, were considered (assignments of peak relevant for quantification are reported in Table 1). Triad distribution (considering EBE, EHE and EOE, in the absence of others, due to the low amount of these comonomers) was obtained from the integration of relevant peaks in ¹³C NMR spectrum (possible overlaps of the peaks of the antioxidant AO1010 were considered), using the following relations:

$$\begin{matrix}PPP = 100 {I}_{11} / Σ \\ for {I}_{3} / {I}_{4} < 1 : PPE = 100 {I}_{3} / Σ \\ for {I}_{3} / {I}_{4} > 1 : PPE = 100 ( {I}_{8} - 6 {I}_{4} ) / Σ \\ EPE = 100 {I}_{7} / Σ \\ EBE = 100 {I}_{1} / Σ \\ EHE = 100 {I}_{6} / Σ \\ EOE = 100 ( {I}_{2} - {I}_{6} ) / Σ \\ XEX = 100 {I}_{13} / Σ \\ XEE = 100 ( {I}_{12} - {I}_{2} ) / Σ \\ EEE = 100 ( 0.5 ( {I}_{10} - {I}_{2} ) + 0.25 ( {I}_{9} + {I}_{8} ) ) / Σ \\ Where :\end{matrix}$$

$$Σ = {I}_{11} + ( {I}_{3} or ( {I}_{8} - 6 {I}_{4} ) ) + {I}_{7} + {I}_{1} + {I}_{6} + {I}_{2} - {I}_{6} + {I}_{13} + {I}_{12} - {I}_{2} + 0.5 ( {I}_{10 -} {I}_{2} ) + 0.25 ( {I}_{9} + {I}_{8} )$$

and Iₙ are the areas of the corresponding carbon following the numbering scheme reported in Table 1. In some instances, X was propylene, 1-butene, 1-hexene or 1-octene.

The molar content of Ethylene, Propylene, 1-Butene and 1-Octene was obtained from triads using the following relations:

$$\begin{matrix}P ( m \% ) = PPP + PPE + EPE \\ B ( m \% ) = EBE \\ H ( m \% ) = EHE \\ O ( m \% ) = EOE \\ E ( m \% ) = EEE + XEE + XEX\end{matrix}$$

Molar content was transformed in weight using monomer's molecular weight.

### Evaluation of ¹H NMR Spectrum

The molar content of Polyethylene terephthalate (PET), Polystyrene (PS) and ethylene/propylene/1-butene/1-hexene/1-octene copolymers were obtained from ¹H spectra.

The aromatic hydrogen peaks of PET and PS (assignments according to Table 2) were used, while the amount of ethylene/propylene/1-Butene/1-Hexene/1-Octene copolymers was determined by the integral of the aliphatic hydrogens, from which the contribution of the 3 aliphatic hydrogens of the polystyrene was subtracted.

Molar amounts of PET, PS and E/P/B/H/O copolymers were evaluated from the following relations:

$$\begin{matrix}PET = 100 0.25 {I}_{a} / Σ \\ PS = 100 0.5 {I}_{c} / Σ \\ Total aliphatic E / P / B / H / O copolymers = 100 0.5 ( {I}_{e} - 3 PS - 9 {I}_{d} ) / Σ \\ Where Σ = 0 \text{.25} {I}_{a} + 0.5 {I}_{c} + 0.5 ( {I}_{d} - 3 PS - 100 0.5 ( {I}_{e} - 3 P S - 9 {I}_{d} ) / Σ\end{matrix}$$

Molar content was transformed in weight percentage using monomer's molecular weight, considering the MW of CH₂ to estimate the weight contribution from ethylene/propylene/1-butene/1-hexene/1-octene copolymers.

The weight content of P, E, B, H and O obtained from 13C spectrum was rescaled to obtain the weight percentage in the whole sample by multiplying each value (wt. %) from triads with the rescaling factor “RF”:

RF=[100−PET(wt. %)−PS(wt. %)]/100, where PET (wt. %) and PS (wt. %) are the compositions obtained from ¹H spectrum.

TABLE a
Assignments of the ¹³C NMR spectrum of
Ethylene/Propylene/1-Octene/1-Butene copolymers

| Number | Chemical Shift (ppm) | Carbon | Sequence |
|---|---|---|---|
| 1 | 39.6 | T_{δδ} | EBE |
| 2 | 38.8 | T_{δδ} | EOE + EHE |
| 3 | 38.2-37.6 | S_{αγ} | PE |
| 4 | 36.2 | CH₂ | AO1010 |
| 6 | 34.0 | 4B₄ | EHE |
| 7 | 33.3-33.2 | T_{δδ} | EPE |
| 8 | 30.8-30.7 | T_{βδ} | PPE |
| 8 | 30.3 | S_{γδ} | XEEE |
| 9 | 30.2 | S_{γδ} | PEEE |
| 10 | 29.9 | S_{δδ} + 4_{β6} | EEE + O |
| 11 | 28.8-28.2 | T_{ββ} | PPP |
| 12 | 27.4-26.7 | S_{βδ} + 5_{β6} | XE + O |
| 13 | 24.7-24.1 | S_{ββ} | XEX |

TABLE b
Assignments of the ¹H NMR spectrum of Ethylene/Propylene/
1-Butene/1-Hexene/1-Octene copolymers containing PS and PET

| Number | Chemical Shift (ppm) | Proton | Sequence |
|---|---|---|---|
| a | 8.08 | CH | PET |
| b | 7.20-6.81 | CH | PS |
| c | 6.81-6.33 | CH | PS |
| d | 2.91 | CH₂ | AO1010 |
| e | 1.80-0.70 | CH + CH₂ + CH₃ | Total aliphatic |
| | 1.25 | CH + CH₂ | PS |

### Ethylene (C2) Content

### ¹³C NMR of Propylene/Ethylene Copolymers Components B) and C)

¹³C NMR spectra were acquired on a Bruker AV-600 spectrometer equipped with cryoprobe, operating at 160.91 MHz in the Fourier transform mode at 120° C.

The peak of the S_{ββ} carbon (nomenclature according to “Monomer Sequence Distribution in Ethylene-Propylene Rubber Measured by ¹³C NMR. 3. Use of Reaction Probability Mode” C. J. Carman, R. A. Harrington and C. E. Wilkes, Macromolecules, 1977, 10, 536) was used as internal standard at 29.9 ppm. The samples were dissolved in 1,1,2,2-tetrachloroethane-d2 at 120° C. with an 8% wt/v concentration. Each spectrum was acquired with a 90° pulse, 15 seconds of delay between pulses and CPD, thereby removing ¹H-13C coupling. 512 transients were stored in 32K data points using a spectral window of 9000 Hz.

The assignments of the spectra, the evaluation of triad distribution and the composition were made according to Kakugo (“Carbon-13 NMR determination of monomer sequence distribution in ethylene-propylene copolymers prepared with δ-titanium trichloride-diethylaluminum chloride” M. Kakugo, Y. Naito, K. Mizunuma and T. Miyatake, Macromolecules 1982, 15, 4, 1150-1152) using the following equations:

$$\begin{matrix}PPP = 100 {T}_{ββ} / S & PPE = 100 {T}_{βδ} / S & EPE = 100 {T}_{δδ} / S \\ PEP = 100 {S}_{ββ} / S & PEE = 100 {S}_{βδ} / S & EEE = 100 ( 0.25 {S}_{γδ} + 0.5 {S}_{δδ} ) / S\end{matrix}$$

$$S = {T}_{ββ} + {T}_{βδ} + {T}_{δδ} + {S}_{ββ} + {S}_{βδ} + 0.25 {S}_{γ δ} + 0.5 {S}_{δδ}$$

The molar percentage of ethylene content was evaluated using the following equation:

$$E \% mol = 100 * [ PEP + PEE + EEE ]$$

The weight percentage of ethylene content was evaluated using the following equation:

$$E \% wt . = \frac{100 * E \% mol * {MW}_{E}}{E \% mol * {MW}_{E +} P \% mol * {MW}_{P}}$$

where P % mol is the molar percentage of propylene content, while MWE and MWP are the molecular weights of ethylene and propylene, respectively.

The product of reactivity ratio r₁r₂ was calculated according to Carman (C. J. Carman, R. A. Harrington and C.E. Wilkes, Macromolecules, 1977; 10, 536) as:

$${r}_{1} {r}_{2} = 1 + ( \frac{EEE + PEE}{PEP} + 1 ) - ( \frac{P}{E} + 1 ) {( \frac{EEE + PEE}{PEP} + 1 )}^{0.5}$$

The tacticity of Propylene sequences was calculated as mm content from the ratio of the PPP mmT_{ββ} (28.90-29.65 ppm) and the whole T_{ββ} (29.80-28.37 ppm).

### Xylene-soluble (XS) Fraction at 25° C.

Xylene Solubles at 25° C. were determined according to ISO 16152:2005.

### Melt Flow Rate (MFR)

Measured according to ISO 1133-1 at 230° C. with a load of 2.16 kg or 5 kg, as specified.

### Intrinsic Viscosity (IV)

The sample was dissolved in tetrahydronaphthalene at 135° C. and then poured into a capillary viscometer. The viscometer tube (Ubbelohde type) was surrounded by a cylindrical glass jacket. This setup allowed for temperature control with a circulating thermostatic liquid. The downward passage of the meniscus was timed by a photoelectric device.

The passage of the meniscus in front of the upper lamp started the counter which had a quartz crystal oscillator. The counter stopped as the meniscus passed the lower lamp. The efflux time was registered and converted into a value of intrinsic viscosity through Huggins' equation (Huggins, M. L., J. Am. Chem. Soc., 1942, 64, 2716), using the flow time of the pure solvent at the same experimental conditions (same viscometer and same temperature). A single polymer solution was used to determine [η].

Polydispersity index: Determined at a temperature of 200° C. by using a parallel plates rheometer model RMS-800 marketed by RHEOMETRICS (USA), operating at an oscillation frequency, which increased from 0.1 rad/sec to 100 rad/sec. From the crossover modulus, the P.I. was derived from the equation:

P.I.=105/Gc

wherein Gc is the crossover modulus, which is defined as the value (expressed in Pa) at which G′=G″ wherein G′ is the storage modulus and G″ is the loss modulus.

### Samples for the Mechanical Tests

Samples were obtained according to ISO 1873-2:2007.
Charpy impact test was determined according to ISO 179-1eA, and ISO 1873-2.
Elongation at yield: measured according to ISO 527.
Elongation at break: measured according to ISO 527
Stress at break: measured according to ISO 527.
Tensile Modulus was measured according to ISO 527-2.
Tear Resistance was measured according to the method ASTM D 1004 on 1 mm-thick extruded sheets. Crosshead speed: 51 mm/min; V-shaped die cut specimen.
Shore D was measured on injection molded, compression molded plaques and extruded sheets, according to the method ISO 868 (15 sec).

### Melting Point and Crystallization Point

The melting point was measured by using a DSC instrument, according to ISO 11357-3, at scanning rate of 20C/min both in cooling and heating, on a sample of weight between 5 and 7 mg., under inert N₂ flow. Instrument was calibrated with Indium.

### Example 1

### Component A)

The recycled polypropylene used as component Awas commercially available from Polar and had the features reported in Table 1.

TABLE 1

| | | |
|---|---|---|
| MFR 2.16 kg | g/10 min | 4.81 |
| XS | wt. % | 8 |
| Tm | ° C. | 161.3) |
| Tc | ° C. | 120.1 |
| Charpy 23° C. | KJ/m² | 6.3 |
| Charpy 0° C. | KJ/m² | 3.2 |
| tensile modulus | N/mm² | 1350 |
| Elongation at break 48 h | % | 123 |
| D/B TT | ° C. | >10 |
| C2-(NMR) | Wt. % | 9.35 |
| C3 (NMR) | Wt. % | >75 |

C2 ethylene derived units
FTIR spectrum of film showed at least two peaks at different wavenumbers (cm−1) selected from: 3303±1 cm⁻¹; 1726±1 cm⁻¹; 1642±1 cm⁻¹; 1600±1 cm⁻¹; 1550±1 cm⁻¹; 906±1 cm⁻¹; 839±1 cm⁻¹, 818±1 cm⁻¹; 748±1 cm⁻¹; and 695±1 cm⁻¹.

### Component B)

Component B was an heterophasic polymer, which was commercially available from LyondellBasell, and hade the properties set forth in Table 2:

TABLE 2
Component B)

| | | |
|---|---|---|
| component b1) | | |
| Xs | wt. % | <2.0 |
| MFR 230° C./5 kg | g/10 min | 1.30 |
| split | wt. % | 90 |
| component b2) | | |
| C2 content | wt. % | 49.8 wt. % |
| split | wt. % | 10 |
| total composition | | |
| MFR 230° C./5 kg | g/10 min | 1.1 |
| Xs | wt. % | 10.1 |
| IV on XS | dl/g | 3.9 |
| C2 content | wt. % | 5.0 wt. % |

Xs fraction soluble in xylene at 25° C.
C2 ethylene derived units
IV intrinsic viscosity

### Composition

70 wt. % of component A) was blended with 30 wt. % of component B) in an extruder (Berstorff extruder). 1000 ppm of M.S. 168 and 3000 ppm of DHT-4A, based on the total weight of A+B, were added. The polymer particles were extruded, under nitrogen atmosphere, in a twin screw extruder, at a rotation speed of 250 rpm and a melt temperature of 200-250° C. The resulting composition had the properties reported in Table 3.

TABLE 3
Examples 1

| | | |
|---|---|---|
| MFR 2.16 kg | g/10 min | 2 |
| XS | wt. % | 8.8 |
| Tm | ° C. | 162 |
| Tc | ° C. | 120.8 |
| Charpy 23° C. | KJ/m² | 13.1 |
| Charpy 0° C. | KJ/m² | 5.6 |
| tensile modulus | N/mm² | 1570 |
| Stress at yield 48 h | N/mm² | 30.5 |
| Elongation at yield 48 h | % | 9.2 |
| Elongation at break 48 h | % | 57 |

Contaminants: Phenylcyclohexane and methylstearate were adsorbed on pellets of the composition of Table 3 by contacting the pellets with the compounds at 40° C. under shaking for 15 days.

The concentrations of the contaminants were determined by N₂ grinding, followed by extraction in ultrasonic bath by using a solvent. A GC-MS/MS triple quadrupole (Agilent 7000C and D) was used, equipped with a column Agilent HPMS UI 30 m/0.25 mm/0.25 mm. The detection was performed in MRM (Multiple Reaction Monitoring) mode by identifying the transitions for each compound. Then starting concentration were reported in Table 4.

TABLE 4

| Compound | | Content of contaminant |
|---|---|---|
| Phenylcyclohexane | mg/g | 979 ± 111 |
| methylstearate | mg/g | 771 ± 91 |

BOPP A/B/A films were produced. The A layer was made with Moplen HP740J propylene homopolymer, which was commercially available from LyondellBasell, while the B layer was the contaminated composition of Example 1.

The specific migrations of the employed contaminants were determined onto the samples after a conditioning time of 10 days at 40° C., with some simulants covering foodstuff categories. The following simulants were used: acetic acid 3% w/v (B simulant) and ethanol 10% v/v (A simulant).

The concentrations of the contaminants in the simulants were determined by GC-MS/MS triple quadrupole (Agilent 7000C and D), equipped with a column Agilent HPMS UI 30 m/0.25 mm/0.25 mm. The detection was performed in MRM (Multiple Reaction Monitoring) mode by identifying the transitions for each compound. The results are reported in Table 5.

TABLE 5

| Compound | Simulant A | Simulant B |
|---|---|---|
| Phenylcyclohexane | <0.01 | <0.01 |
| methylstearate | <0.01 | <0.01 |

In some instances, the functional barrier efficiency is stated to a value of 0.01 mg/kg. Therefore, the film of example 1 met the requisite for food contact.

What is claimed is:

1. A multilayer film comprising:
I. at least one core layer comprising
i. a polypropylene composition comprising
A) from 55 wt. % to 85 wt. % of a recycled a recycled polypropylene (r-PP), having the following features:
A.1. a propylene derived units content, measured with ¹³C-NMR, higher than 60 wt. %;
A.2. an ethylene derived units content, measured with ¹³C-NMR, between 1.5 wt. % and 20.3 wt. %;
A.3. a Melt Flow Rate (ISO 1133 230° C./2.16 kg) ranging from 0.2 to 20 g/10 min;
A.4. a fraction soluble in xylene at 25° C., determined according to ISO 16152:2005, lower than 15.0 wt. %;
A.5. a flexural modulus, measured according to ISO 527-2, ranging from 820 N/mm² to 1720 N/mm²;
A.6. a Charpy impact test at 23° C., determined according to ISO 179-1eA, and ISO 1873-2, ranging from 2.2 KJ/m² to 13.0 KJ/m²;
A.7. an elongation at break, measured according to ISO 527, ranging from 50% to 200%; and
A.8. the FTIR spectrum of film showing at least two peaks at different wavenumbers (cm−1) selected from the group consisting of:
3303±1 cm⁻¹; 1726±1 cm⁻¹; 1642±1 cm⁻¹; 1600±1 cm⁻¹; 1550±1 cm⁻¹; 906±1 cm⁻¹; 839±1 cm⁻¹, 818±1 cm⁻¹; 748±1 cm⁻¹; 695+1 cm⁻¹; and
B) from 15 wt. % to 45 wt. % of a virgin polypropylene composition comprising
(b1) from 75 wt. % to 95 wt. % of a propylene homopolymer, having:
(b1.1) a fraction soluble in xylene at 25° C. lower than 6.0 wt. %; and
(b1.2) a Melt Flow Rate (ISO 1133 230° C./5.0 kg) ranging from 0.1 to 6.0 g/10 min; and
(b2) from 5 wt. % to 25 wt. % of a copolymer of propylene and ethylene, having:
(b2.1) units derived from ethylene, measured according to ¹³C-NMR, in an amount ranging from 25.0 wt. % to 68.0 wt. %;
wherein the polypropylene composition (B), having the following features:
B.1. a Melt Flow Rate (ISO 1133 230° C./5.0 kg) ranging from 0.4 to 5.0 g/10 min;
B.2. an amount of fraction soluble in xylene at 25° C. ranging from 7.0 wt. % to 18.0 wt. %;
B.3. an intrinsic viscosity fraction soluble in xylene at 25° C., measured in tetrahydronaphthalene at 135° C., ranging from 1.2 to 7.5 dl/g; and
B.4. a total content of ethylene, measured according to ¹³C-NMR, ranging from 4.0 wt. % to 10.0 wt. %;
wherein, in the polypropylene composition (i), the sum of b1) and b2), being referred to the total weight of b1) and b2), is 100, and the sum of the amounts of (A) and (B), being referred to the total weight of (A) and (B), is 100.

2. The multilayer film according to claim 1, wherein component (A) ranges from 60 wt. % to 80 wt. %; and component (B) ranges from 20 wt. % to 40 wt. %.

3. The multilayer film according to claim 1, wherein component b1) ranges from 81 wt. % to 93 wt. % and component b2) ranges from 7 wt. % to 19 wt %.

4. The multilayer film according to claim 1, wherein component b1) has a Melt Flow Rate (ISO 1133 230° C./5.0 kg) ranging from 0.5 to 2.50 g/10 min.

5. The multilayer film according to claim 1, wherein component b2) has units derived from ethylene, measured according to ¹³C-NMR, ranging from 41.0 wt. % to 57.0 wt. %.

6. The multilayer film according to claim 1, wherein component B) has a Melt Flow Rate (ISO 1133 230° C./5.0 kg) ranging from 0.4 to 3.0 g/10 min.

7. The multilayer film according to claim 1, wherein component (B) has an amount of fraction soluble in xylene at 25° C. ranging from 8.0 wt. % to 16.0 wt. %.

8. The multilayer film according to claim 1, wherein component (B) has an intrinsic viscosity fraction soluble in xylene at 25° C., measured in tetrahydronaphthalene at 135° C., ranging from 3.0 to 7.5 dl/g.

9. The multilayer film according to claim 1, wherein component (B) has a total content of ethylene measured according to ¹³C-NMR, ranging from 4.2 wt. % to 5.8 wt. %.

10. The multilayer film according to claim 1, wherein component A) has a melt flow rate (ISO 1133-1 230° C./2.16 kg) ranging from 1 to 15 g/10 min.

11. The multilayer film according to claim 1, wherein component A) has an ethylene derived units content, measured with ¹³C-NMR, between 3.0 wt. % and 18.2 wt. %.

12. The multilayer film according to claim 1, wherein component A) has a fraction soluble in xylene at 25° C., determined according to ISO 16152:2005, lower than 13.0 wt. %.

13. The multilayer film according to claim 1, wherein component A) has a flexural modulus, measured according to ISO 527-2, ranging from 950 N/mm² to 1550 N/mm².

14. The multilayer film according to claim 1, wherein the outer layers comprises a propylene homopolymer.

15. The multilayer film according to claim 1, having a structure A/B/A or A/B/C, wherein layer B comprises the polypropylene composition and layers A) or C) comprise a polymer different from the polypropylene composition.
